(19) United States
(12) Patent Application Publication
(10) Pub. No.: US 2019/0353802 A1
(43) Pub. Date: Nov. 21, 2019

(54) X-RAY DETECTOR AND X-RAY IMAGING APPARATUS

(71) Applicant: KONINKLIJKE PHILIPS N.V., EINDHOVEN (NL)

(72) Inventors: HEIDRUN STEINHAUSER, EINDHOVEN (NL); ONNO JAN WIMMERS, VALKENSWARD (NL); PETER LEX ALVING, MIERLO (NL); MATTHIAS SIMON, AACHEN (DE)

(21) Appl. No.: 16/474,110

(22) PCT Filed: Dec. 24, 2017
(86) PCT No.: PCT/EP2017/084573

§ 371 Date: Jun. 27, 2019

(30) Foreign Application Priority Data
Jan. 2, 2017 (EP) 17150028.3

(51) Int. Cl. G01T 1/20

(52) U.S. Cl. CPC G01T 1/2002; G01T 1/208; G01T 1/2006

(57) ABSTRACT

An X-ray detector (100) and an X-ray imaging apparatus (500) with such X-ray detector (100) are provided. The X-ray detector (100) comprises at least three scintillator layers (102a-e) for converting X-ray radiation into scintillator light (110), and at least two sensor arrays (104a, 104b), each comprising a plurality of photosensitive pixels (108a, 108b) aranged on a bendable substrate (106a, 106b) for receiving scintillator light (110) emitted by at least one of the scintillator layers (102a-e). Therein, a number of the scintillator layers (102a-e) is larger than a number of the sensor arrays (104a, 104b). The at least three scintillator layers (102a-e) and the at least two sensor arrays (104a, 104b) are arranged on top of each other, wherein at least one of the sensor arrays (104b) is arranged between at least two of the scintillator layers (102a-e), such that said at least two scintillator layers (102a-e) are optically coupled to said at least one sensor array (104b) at two opposite sides (103a, 103b) of said at least one sensor array (104b). Further, said at least one sensor (104b) array is configured to receive light emitted by said at least two scintillator layers (102a-e).

### FIELD OF THE INVENTION

The invention generally relates to the field of radiation detectors. More specifically, the invention relates to an X-ray detector, an X-ray imaging apparatus comprising such X-ray detector and to a method for operating an X-ray imaging apparatus with such X-ray detector.

### BACKGROUND OF THE INVENTION

Spectral X-ray imaging has become an increasingly important field as additional information may be gained from several X-ray images acquired at different energies and/or at different energy ranges of X-ray radiation.

For spectral X-ray imaging various types of X-ray detectors have been developed. One example of such X-ray detector is a so-called dual layer detector, also referred to as sandwich detector, in which e.g. two photodetectors with scintillators are arranged on top of each other.

Usually, an X-ray hardening filter is arranged between the two photodetectors. By means of the X-ray hardening filter an energy separation between X-rays detected by the two photodetectors may be increased, thereby increasing attenuation differences for different materials of an irradiated object. However, the X-ray hardening filter may also absorb a portion of incoming X-rays, particularly low-energy X-rays, thereby potentially adversely affecting a dose efficiency of the X-ray-detector.

### SUMMARY OF THE INVENTION

It may be an object of the present invention to provide an improved X-ray detector having an improved detection efficiency.

This object is achieved by the subject matter of the independent claims, wherein further embodiments are incorporated in the dependent claims and the following description.

According to a first aspect of the invention, an X-ray detector is provided. The X-ray detector comprises at least three scintillator layers for converting X-ray radiation into scintillator light, such as e.g. visible light. The X-ray detector further comprises at least two sensor arrays, wherein each of the at least two sensor arrays comprises a plurality of photosensitive pixels for receiving scintillator light emitted by at least one of the scintillator layers. Therein a number of the scintillator layers is larger than a number of the sensor arrays. The at least three scintillator layers and the at least two sensor arrays are arranged and/or stacked on top of each other. Further, at least one of the sensor arrays is arranged between at least two of the scintillator layers, such that said at least two scintillator layers are optically coupled to said at least one sensor array at two opposite sides of said at least one sensor array. Moreover, said at least one sensor array is configured and/or arranged to receive light emitted by said at least two scintillator layers.

According to an example of the first aspect, the photosensitive pixels of each of the sensor arrays are arranged on a bendable and/or flexible substrate. Particularly, each of the sensor arrays may be arranged on a separate bendable and/or flexible substrate. However, the sensor arrays may alternatively be aranged on a common substrate. Arranging the sensor arrays and/or the photosensitive pixels of each of the sensor arrays on a bendable substrate may particulary allow to provide a bendable, flexible and/or curved X-ray detector. Accordingly, the X-ray detector and/or each of the scintillator layers may be bendable and/or flexible. By way of example, the bendable substrate may be a bendable and/or flexible substrate foil. Here and in the following the term “bendable” and/or “flexible” may mean that the substrate may be folded and/or convolved at least 10⁵ times without any deterioration, deterioration-free and/or wearlessly. Also, the X-ray detector may be folded and/or convolved at least 10⁵ times deterioration-free, without any deterioration and/or wearlessly.

According to a second aspect of the invention, an X-ray imaging apparatus with such X-ray detector is provided.

According to a third aspect of the invention, a method for operating an X-ray imaging apparatus with an X-ray detector according to the first aspect is provided.

It should be noted that features, elements, characteristics and/or functions of the X-ray detector as described above and in the following may be features, elements, characteristics and/or functions of the X-ray imaging apparatus as well as features, elements, characteristics and/or steps of the method. Vice versa, features, elements, characteristics and/or functions of the X-ray imaging apparatus as well as features, elements, characteristics and/or steps of the method as described above and in the following may be features, elements, characteristics and/or functions of the X-ray detector. In other words, all features, functions, characteristics, steps and/or elements described with respect to one aspect of the invention may also refer to any of the other aspects of the invention.

Here and in the following the term “photosensitive pixel” may refer to a detection element configured for detecting electromagnetic radiation emitted by at least one of the scintillator layers. Accordingly, the term scintillator light may refer to electromagnetic radiation emitted by at least one of the scintillator layers. The photosensitive pixels may be arranged in an arbitrary pattern in the respective sensor array.

Each of the plurality of scintillator layers may comprise any scintillation material, such as e.g. CsI, GOS (Gadolinium Oxysulfide), garnet (e.g. LGGAG, Lutetium Gadolinium Gallium Aluminum Garnet), and/or NaI, which scintillation material can be excited by photons and/or charged particles and de-excite by emission of scintillator light. Further, the scintillator material may be a columnar grown scintillator material and/or a non-columnar grown scintillator material. The scintillator layers of the X-ray detector may comprise the same scintillator material or at least a part of the plurality of scintillator layers may comprise different scintillator materials.

Further, the term “optically coupled” may refer to optically connected and/or directly coupled, such that scintillator light emitted by at least one the scintillators may be transmitted to and/or impinge onto the at least one sensor array and/or onto at least a part of the photosensitive pixels thereof in order to be detected. Thus, optically coupled may mean that scintillator light may reach the respective sensor array without significant absorption.

Re-phrasing the first aspect of the invention, the X-ray detector comprises a plurality of scintillator layers and a plurality of sensor arrays. The scintillator layers and the sensor arrays are stacked on top each other along a stacking direction of the X-ray detector. Thus, the X-ray detector may comprise a sandwich structure of scintillator layers and sensor arrays, wherein the X-ray detector may refer to a dual layer X-ray detector and/or a sandwich detector. Further, at least one of the sensor arrays is arranged between at least two of the scintillator layers, such that said at least two scintillator layers are separated along the stacking direction by said at least one sensor array. Thus, said at least two scintillator layers may be arranged on and/or may be in contact with two opposite sides of said at least one sensor array, wherein the two opposite sides of the sensor array may oppose each other with respect to the stacking direction. The two opposite sides of the sensor array may refer to opposite surfaces of the sensor array. Further, said at least one sensor array may be arranged and/or configured to receive and/or collect scintillator light emitted by said at least two scintillator layers arranged on the two opposite sides of the sensor array.

The invention may be regarded as being based on the following findings. Using a dual layer X-ray detector for dual energy X-ray imaging may mean that an X-ray attenuation measured in the X-ray detector may be detected by at least two sensor arrays arranged on top of each other. Accordingly, X-ray radiation impinging onto the X-ray detector may be distributed among the scintillator layers comprised in the X-ray detector. By way of example, a first scintillator layer arranged close to an X-ray source may be configured for converting a low energy portion of the X-ray radiation into scintillator light and a second scintillator layer, arranged further away from the X-ray than the first scintillator layer, may be configured for converting a high energy portion of the X-ray radiation into scintillator light. In conventional X-ray detectors, a first sensor array may be arranged between the two scintillator layers and a second sensor array may be arranged underneath the second scintillator layer. This way, a low energy X-ray image may be acquired with the first sensor array, which may be arranged closer to the X-ray source than the second sensor array, and a high-energy X-ray image may be acquired with the second sensor array. In order to increase an energy separation between the two sensor arrays, the second scintillator layer is usually rather thick, particularly thicker than the first scintillator layer, in order to absorb as many of the high energetic X-ray quanta as possible. However, a thicker scintillator layer may deteriorate a modulation transfer function (MTF) of the X-ray detector and/or the respective scintillator layer, e.g. due to scattering and/or spreading of the scintillator light within the respective scintillator layer. Further, a conventional X-ray detector may have a low detective quantum efficiency (DQE) of the first and second X-ray images, wherein the first X-ray image and/or the second X-ray image may refer to either a low-energy X-ray image or a high-energy X-ray image.

In contrast to conventional X-ray detectors, in the X-ray detector according to the invention at least one of the sensor arrays is configured to receive and/or collect scintillator light emitted by at least two scintillator layers arranged on two opposite sides of the respective sensor array. Thus, this at least one sensor array may be illuminated by scintillator light from two opposite sides. As a consequence, e.g. a scintillator layer arranged between the at least two sensor arrays may be thinner compared to conventional X-ray detectors, thereby decreasing a deterioration of the modulation transfer function. For instance, compared to conventional X-ray detectors, the second scintillator layer may be split and two thin scintillator layers may be arranged on two opposite sides of the at least one sensor array. Accordingly, a number of high energetic X-ray photons and/or X-ray quanta converted and/or absorbed in the scintillator layers arranged on two opposite sides may be maximized, thereby increasing, improving and/or optimizing the DQE with respect to conventional X-ray detectors. Further, the MTF may be improved and/or optimized with respect to conventional X-ray detectors. As a consequence, also thinner scintillator layers and/or scintillator layers of faster de-exciting non-columnar grown scintillator material may be used. Overall, a detection efficiency of the X-ray detector may be improved.

Apart from that, as the scintillator stack for the high energy X-ray image can be made thicker, also the low energy scintillator can be made thicker. This may further improve an image quality for spectral X-ray imaging using the inventive X-ray detector.

Also an image quality in non-spectral X-ray imaging, where images acquired with the at least two sensor arrays may be added, may be improved because of a higher total X-ray absorption in the X-ray detector.

Therefore, the inventive X-ray detector may have improved detector characteristics, both for spectral and non-spectral X-ray imaging, and may have several advantages compared to conventional detectors as summarized in the following. Particularly, the inventive X-ray detector may have an improved DQE both in spectral and non-spectral X-ray imaging. Further, the proposed X-ray detector enables an increased MTF for the high energy X-ray image, which allows to use faster scintillator non-columnar grown material without compromising MTF compared to conventional X-ray detectors.

By using at least one sensor array that can be illuminated from two sides with scintillator light, the DQE may be improved for both, dual energy (i.e. spectral) and non-spectral X-ray imaging. In non-spectral X-ray imaging the individual scintillator layers can be thinner than in a conventional detector, which may lead to an improved MTF, while the total scintillator layer thickness, i.e. the sum of thicknesses of all scintillator layers in the X-ray detector, can be increased, which may improve the DQE. Further, in spectral X-ray imaging and/or dual energy X-ray imaging, a scintillator layer arranged between the at least two sensor arrays may be split into two thinner scintillator layers, thus more high energetic X-ray quanta can be absorbed compared to a conventional X-ray detector, while also the MTF can be improved with respect to conventional X-ray detectors. Moreover, as X-ray quantum noise in the two X-ray images acquired with the at least two sensor arrays may be desired to be comparable, also the low energy scintillator layer may be thicker than in conventional X-ray detectors. This also results in an X-ray detector with improved DQE.

According to an embodiment, each of the at least two sensor arrays is arranged between at least two of the scintillator layers. Alternatively or additionally each of the sensor arrays is configured to receive light emitted by at least two of the scintillator layers arranged on two opposite sides of the respective sensor array. By way of example, the X-ray detector may comprise a stack of two sensor arrays and three scintillator layers, wherein the sensor arrays and the scintillator layers are alternately arranged on top of each other, and wherein two of the scintillator layers are arranged on two outer sides of the X-ray detector. This way, DQE and/or an overall detection efficiency may be further improved.

According to an embodiment, the X-ray detector further comprises at least one switchable optical filter, wherein the at least one switchable optical filter is switchable between a first state, in which the switchable optical filter is transparent for scintillator light, and a second state, in which the switchable optical filter is blocking scintillator light. In the first state, scintillator light may traverse the switchable optical filter unhindered, i.e. with nearly no absorption. In contrast, in the second state, scintillator light may be absorbed and/or reflected by the switchable optical filter. Generally, this increases an overall versatility of the X-ray detector in terms of allowing the X-ray detector to be operated in various different operation modes.

According to an embodiment, the switchable optical filter is an electrochromic optical filter. The switchable optical filter may be configured to switch between the first state and the second state by receiving an electrical signal, e.g. from a controller of an X-ray imaging apparatus and/or from a controller of the X-ray detector. The switchable optical filter may e.g. comprise viologen, transition metal oxide, such as e.g. tungsten trioxide, and/or any other suitable material. Moreover, the switchable optical filter may also comprise one or more liquid crystals.

The switchable optical filter may have a pixel structure and/or the switchable optical filter may be a pixelated switchable optical filter. In other words, the switchable optical filter may comprise an array of switchable optical filter elements. The pixel structure of the switchable optical filter may correlate with a geometrical arrangement of the photosensitive pixels of at least one of the sensor arrays. Accordingly, the pixel structure of the switchable optical filter may be matched with at least one of the sensor arrays and/or with a geometrical arrangement of the photosensitive pixels of at least one of the sensor arrays. Thus, the state of the switchable optical filter may be the same for all switchable optical filter elements or the state may be controlled pixel-wise, such that a part of the switchable optical filter elements may be in the first state and another part of the switchable optical filter elements may be in the second state. Therein, each switchable optical filter element may be controlled and/or switched independently. By way of example, a region of interest may be in another state than the rest of the switchable optical filter.

Apart from that, the switchable optical filter may be based on and/or employ an electro-wetting technique, in which properties of a material may be modified by applying a voltage to the material. This may allow to e.g. modify a geometrical extension of each of the switchable optical filter elements.

According to an embodiment, the at least one switchable optical filter is arranged between the at least two sensor arrays. Accordingly, the at least two sensor arrays may be separated by the switchable optical filter along the stacking direction of the X-ray detector.

According to an embodiment, the X-ray detector comprises at least one center scintillator layer arranged between the at least two sensor arrays, wherein the at least one switchable optical filter is arranged between at least one of the sensor arrays and the at least one center scintillator. Accordingly, the at least two sensor arrays may be separated along the stacking direction by the at least one switchable optical filter and said at least one center scintillator layer. The at least one switchable optical filter may be arranged on and/or in contact with a side of one of the respective sensor array. This allows to block scintillator light from this particular side of the respective sensor array, when the switchable optical filter is in the second state. Further, as the switchable optical filter may be configured to reflect scintillator light in the second state, the scintillator light may be reflected back to the further sensor array. Apart from increasing a versatility of the X-ray detector, this allows to further improve an image quality and/or an overall detection efficiency.

According to an embodiment, the X-ray detector comprises a first outer scintillator layer arranged on a first outer side of the X-ray detector. The first outer scintillator layer may refer to a top scintillator layer of the X-ray detector. Further, the X-ray detector comprises a second outer scintillator layer arranged on a second outer side of the X-ray detector opposite to the first outer side. The second scintillator layer may refer to a bottom scintillator layer of the X-ray detector. Moreover, the X-ray detector comprises at least one center scintillator layer arranged between the at least two sensor arrays. Therein, between each of the at least two sensor arrays and the at least one center scintillator layer at least one switchable optical filter is arranged. Accordingly, scintillator light emitted by the at least one center scintillator layer may be blocked from either of the at least two sensor arrays by switching the respective switchable optical filter to the second state, in which scintillator light may be absorbed and/or reflected. This further increases a number of operation modes and thus a versatility of the X-ray detector. Such operation modes may e.g. refer to one of the switchable optical filters being switched to the first state and the other switchable optical filter being switched to the second state. Also both switchable optical filters may be switched to the first state or to the second state.

According to an embodiment, a further center scintillator layer is arranged between the at least two sensor arrays, wherein at least one further switchable optical filter is arranged between the two center scintillator layers. In other words, the X-ray detector may comprise three switchable optical filters, wherein the three switchable optical filters and the at least two center scintillator layers may be alternately arranged on top each other as well as arranged between the at least two sensor arrays. By providing a further center scintillator layer between the at least two sensor arrays, an energy separation between the at least two sensor arrays may be increased.

According to an embodiment, the X-ray detector further comprises at least one opaque layer for absorbing scintillator light. Additionally or alternatively, the X-ray detector may comprise at least one reflective layer for reflecting scintillator light. The opaque layer and or the reflective layer may be arranged between the at least two sensor arrays. The opaque layer and/or the reflective may also be arranged on an outer side and/or on an outer surface of the X-ray detector. By means of such opaque layer and/or such reflective layer e.g. optical cross-talk may be eliminated and/or reduced between different scintillator layers.

According to an embodiment, the photosensitive pixels of each of the sensor arrays are arranged on a substrate. Particularly, the substrate may be a thin and/or an ultra-thin substrate. Therein, the substrate may comprise glass and/or polymer material. Particularly, the substrate may be flexible, bendable and/or transparent for scintillator light. By way of example, the substrate may be a substrate foil comprising polymer material, such as e.g. Polylmide (PI), PolyTetraFluoroEthylene (PTFE), PolyEthylene Terephtalate (PET), PolyEthylen Naphtalate (PEN), and/or any combination thereof. A thickness of the substrate may range from several μm to about 1 mm, and particularly from about 5 μm to 500 μm, more particularly from about 10 μm to about 100 μm. By arranging the photosensitive pixels on such thin and/or transparent substrate, two opposite sides of the respective sensor array may be used for detecting scintillator light. Also, this may allow to provide a cost-efficient, compact, flat, flexible, curved and/or bendable X-ray detector.

Moreover, also the electronics, such as an addressing and/or read-out circuitry, of at least one of the senor arrays may be transparent to enable the respective sensor array to collect and/or receive scintillator light from two scintillator layers arranged on two opposite sides of the respective sensor array.

According to an embodiment, the X-ray detector further comprises at least one metal layer for filtering X-ray radiation. The at least one metal layer may be arranged between the at least two sensor arrays in order to increase energy separation between the at least two sensor arrays. The metal layer may comprise any suitable high-Z material for absorbing X-ray photons, such as e.g. Cu, Sn and/or Ag. A thickness of the metal layer may range from about 10 μm to about 500 μm, particularly from about 50 μm to about 200 μm.

According to the second aspect of the invention, an X-ray imaging apparatus is provided. The X-ray imaging apparatus comprises an X-ray source arrangement for emitting X-ray radiation and an X-ray detector, as described above and in the following, for detecting X-ray radiation emitted by the X-ray source arrangement. The X-ray source arrangement may refer to a multi X-ray source or to a single X-ray source. Further, the X-ray imaging apparatus comprises a controller for controlling the X-ray source and/or the X-ray detector. The X-ray source arrangement and the X-ray detector may be rotatable around a rotational axis of the X-ray imaging apparatus, thereby allowing 3D imaging.

The controller may refer to e.g. a control circuitry, a control module and/or a control unit. The controller may comprise various sub-modules and/or sub-circuitries, such as e.g. an image processing module and/or an image processor for processing image data.

Generally, the X-ray imaging apparatus may refer to any X-ray imaging apparatus. Particularly, the X-ray imaging apparatus may be configured for 3D-imaging. Accordingly, the X-ray imaging apparatus may refer to computed tomography (CT) apparatus, a C-arm system and/or a cone beam CT (CBCT) apparatus.

The X-ray detector may be flat, curved, bendable and/or flexible. Also the X-ray detector may be arranged substantially on an entire CT or CBCT gantry. Thus, apart from one or more apertures for the X-ray source arrangement, the X-ray detector may cover the entire gantry.

According to an embodiment, the X-ray source arrangement and the X-ray detector are rotatable around a rotational axis of the X-ray imaging apparatus, wherein the X-ray source arrangement comprises at least a first X-ray source for emitting a first X-ray beam of a first energy range and a second X-ray source for emitting a second X-ray beam of a second energy range different from the first energy range. The first X-ray beam may e.g. refer to a low energy and/or low kV beam, and the second X-ray beam may refer to a high energy and/or high kV beam. The first and second X-ray beams may advantageously be used for spectral X-ray imaging. Further, the controller is configured for triggering the first X-ray source and for acquiring a first X-ray image, when the first X-ray source is located at an acquiring position around the rotational axis, wherein the controller is configured for triggering the second X-ray source and for acquiring a second X-ray image, when the second X-ray source is located at the acquiring position around the rotational axis.

It is to be noted that the triggering of the first X-ray source and/or the second X-ray source is not restricted to the X-ray detector as described above and in the following. In other words, the triggering of the first X-ray source and/or the second X-ray source may be used with any type of X-ray detector. Accordingly, the X-ray imaging apparatus may comprise any type of X-ray detector.

Given that the X-ray detector comprises at least two sensor arrays, each of these at least two sensor arrays may acquire a separate image. Thus, the first X-ray image and the second X-ray image may refer to image pairs captured with the at least two sensor arrays, respectively, at a certain beam energy. As the X-ray detector comprises at least two sensor arrays, wherein each of the sensor arrays may be configured for measuring and/or detecting X-rays in a different energy range, irradiating such X-ray detector with two X-ray beams of different energy may advantageously allow dose efficient combinations of the images acquired by means of the two sensor arrays at the two different beam energies, as will be described in more detail with reference to the drawings.

Generally, in above-mentioned embodiments the X-ray imaging apparatus and/or the controller may be configured to synchronize a rotation speed of the X-ray detector with an X-ray exposure. In other words, an acquisition frequency may be synchronized with a rotation frequency of the X-ray detector and/or the X-ray source arrangement. As a consequence, the first X-ray image and the second X-ray image may be coincident in space. Also, the first X-ray image and the second X-ray image may be quasi-simultaneous in time, if for example the first and second X-ray sources are spatially close to each other.

According to an embodiment, the X-ray source arrangement comprises an X-ray tube with a first focal spot for emitting the first X-ray beam and a second focal spot for emitting the second X-ray beam. Alternatively or additionally, the X-ray source arrangement comprises a first X-ray tube for emitting the first X-ray beam and a second X-ray tube for emitting the second X-ray beam. Accordingly, the X-ray source arrangement may comprise a stereo X-ray tube and/or a dual focal spot X-ray tube.

According to the third aspect, a method for operating an X-ray imaging apparatus with an X-ray detector, as described above and in the following, and an X-ray source arrangement is provided. The X-ray source arrangement comprises a first X-ray source for emitting a first X-ray beam of a first energy range and a second X-ray source for emitting a second X-ray beam of a second energy range different from the first energy range. The method comprises the steps of:

emitting the first X-ray beam with the first X-ray source, when the first X-ray source is located at an acquiring position around a rotational axis of the X-ray imaging apparatus;

acquiring a first X-ray image with the X-ray detector, when the first X-ray source is located at the acquiring position;

emitting the second X-ray beam with the second X-ray source, when the second X-ray source is located at the acquiring position; and

acquiring a second X-ray image with the X-ray detector, when the second X-ray source is located at the acquiring position.

It is to be noted that any feature, characteristic, element and/or function described above and in the following with respect to the X-ray detector and/or the X-ray imaging apparatus may be a feature, characteristic, element and/or step of the method, and vice versa.

The aspects of the invention described above as well as other aspects of the invention will be apparent from and elucidated with reference to the embodiments described hereinafter.

### BRIEF DESCRIPTION OF THE DRAWINGS

The subject matter of the invention will be explained in more detail in the following with reference to exemplary embodiments which are illustrated in the attached figures, wherein:

FIGS. 1A to 1D each show schematically an X-ray detector according to an example;

FIG. 2 shows schematically an X-ray detector according to an embodiment;

FIG. 3A shows schematically an X-ray detector according to an embodiment;

FIGS. 3B, 3C, 3D each schematically illustrate an operation mode of the X-ray detector of FIG. 3A;

FIGS. 4A and 4B show schematically an X-ray detector according to an embodiment;

FIGS. 5A and 5B show schematically an X-ray detector according to an embodiment;

FIG. 6 shows schematically an X-ray detector according to an embodiment;

FIG. 7 shows schematically an X-ray detector according to an embodiment;

FIG. 8 shows schematically an X-ray imaging apparatus according to an embodiment;

FIG. 9 shows schematically an X-ray imaging apparatus according to an embodiment;

FIG. 10 shows a flow chart illustrating steps of a method for operating an X-ray imaging apparatus according to an embodiment.

In principle, identical, like and/or similar elements are provided with the same reference symbols in the figures. The figures are not to scale.

### DETAILED DESCRIPTION OF EMBODIMENTS

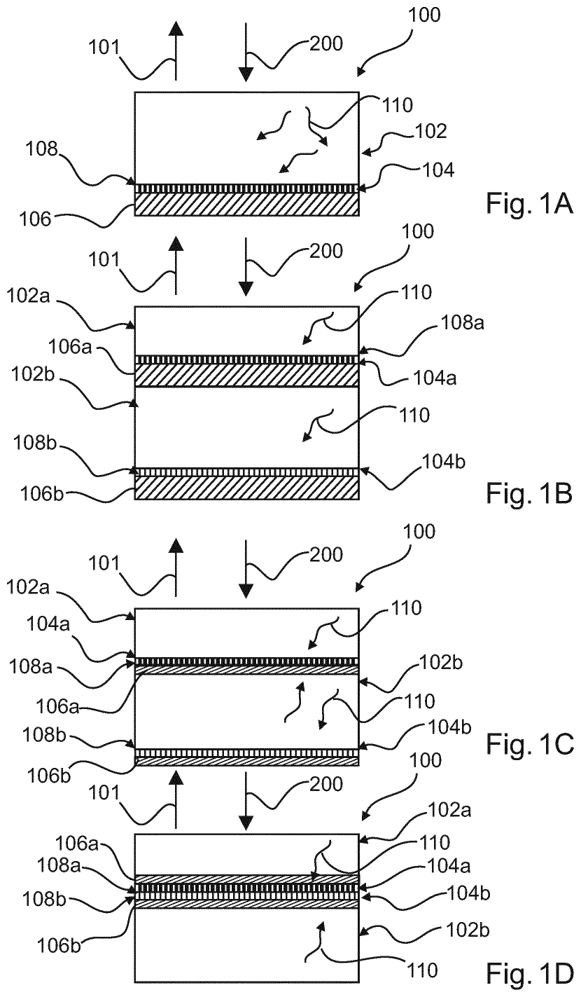

FIG. 1A shows schematically an X-ray detector 100 according to an example.

The X-ray detector 100 of FIG. 1A comprises a scintillator layer 102 arranged on top of a sensor array 104. Therein, the scintillator layer 102 is stacked on top of the sensor array 104 along a stacking direction 101 of the X-ray detector 100.

The sensor array 104 comprises a glass substrate 106, on which a plurality of photosensitive pixels 108 are arranged.

X-ray radiation may impinge along an impinging direction 200 onto the X-ray detector 100, wherein the impinging direction 200 may be substantially antiparallel to the stacking direction 101. X-ray photons and/or X-ray quanta impinging onto the scintillator layer 102 are at least partly converted into scintillator light 110, which in turn is detected by at least a part of the photosensitive pixels 108 of the sensor array 104.

FIG. 1B shows schematically an X-ray detector 100 according to an example. If not stated otherwise, the X-ray detector 100 of FIG. 1B comprises the same features and/or elements as the X-ray detector 100 of FIG. 1A.

The X-ray detector 100 of FIG. 1B is a so-called dual energy X-ray detector 100 comprising a first scintillator layer 102a, a second scintillator layer 102b and a first sensor array 104a arranged between the first scintillator layer 102a and the second scintillator layer 102b. Underneath the second scintillator layer 102b a second sensor array 104b is arranged. Accordingly, along the stacking direction 101, the second sensor array 104b, the second scintillator layer 102b, the first sensor array 104a and the first scintillator layer 102a are stacked on top each other.

The first sensor array 104a comprises a first glass substrate 106a, on which a plurality of photosensitive pixels 108a is arranged. Similarly, the second sensor array 104b comprises a second glass substrate 106b, on which a plurality of photosensitive pixels 108b is arranged.

X-ray radiation impinging onto the X-ray detector 100 along impinging direction 200 usually comprises a certain energy range of X-ray photons. A low-energy portion of the X-ray radiation may be absorbed in the first scintillator layer 102a and generate scintillator light 110 in the first scintillator layer 102a. This scintillator light 110 generated in the first scintillator layer 102a is then detected by the first sensor array 104a. Thus, the first sensor array 104a may be configured for acquiring a low-energy X-ray image.

A high-energy portion of the X-ray radiation may, due to an increased mean free path length of high-energy X-ray photons, traverse the first scintillator layer 102a and the first sensor array 104a and generate scintillator light 110 in the second scintillator layer 102b. The scintillator light 110 generated in the second scintillator layer 102b by high-energetic X-ray photons is then detected by the second sensor array 104b. Thus, the second sensor array 104b may be configured for acquiring a high-energy X-ray image. Accordingly, by means of the X-ray detector 100 of FIG. 1B an image pair with a low-energy image and a high-energy image may be acquired in a single exposure of the X-ray detector 100 with X-ray radiation. In order to increase an energy separation between the first sensor array 104a and the second sensor array 104b, the second scintillator layer 102b may be thicker than the first scintillator layer 102a, wherein a thickness of the scintillator layers 102a,b may be measured along the stacking direction 101.

FIG. 1C shows schematically an X-ray detector 100 according to an example. If not stated otherwise, the X-ray detector 100 of FIG. 1C comprises the same features and/or elements as the X-ray detectors 100 of FIGS. 1A and 1B.

In contrast to the X-ray detector 100 of FIG. 1B, the X-ray detector 100 of FIG. 1C comprises a first sensor array 104a with a substrate 106a comprising polymer material. The substrate 106a may be a thin polymer foil, on which the photosensitive pixels 108a are arranged. Such sensor array 104a is also referred to as detector on foil.

Similarly, also the substrate 106b of the second sensor array 104b is a thin substrate foil comprising polymer material. This may allow to provide a cost-efficient, compact, flat, curved, bendable and/or flexible X-ray detector 100.

Analog to the X-ray detector 100 of FIG. 1B, the X-ray detector of FIG. 1C is a dual energy X-ray detector 100 configured for acquiring a low-energy image and a high energy image.

FIG. 1D shows schematically an X-ray detector 100 according to an example. If not stated otherwise, the X-ray detector 100 of FIG. 1D comprises the same features and/or elements as the X-ray detectors 100 shown in previous figures.

In contrast to the X-ray detector 100 of FIG. 1C, the first sensor array 104a and the second sensor array 104b of the X-ray detector 100 of FIG. 1D are arranged back-to-back. Accordingly, along the stacking direction 101, the X-ray detector 100 comprises the second scintillator layer 102b, the second sensor array 104b, the first sensor array 104a, and the first scintillator layer 102a.

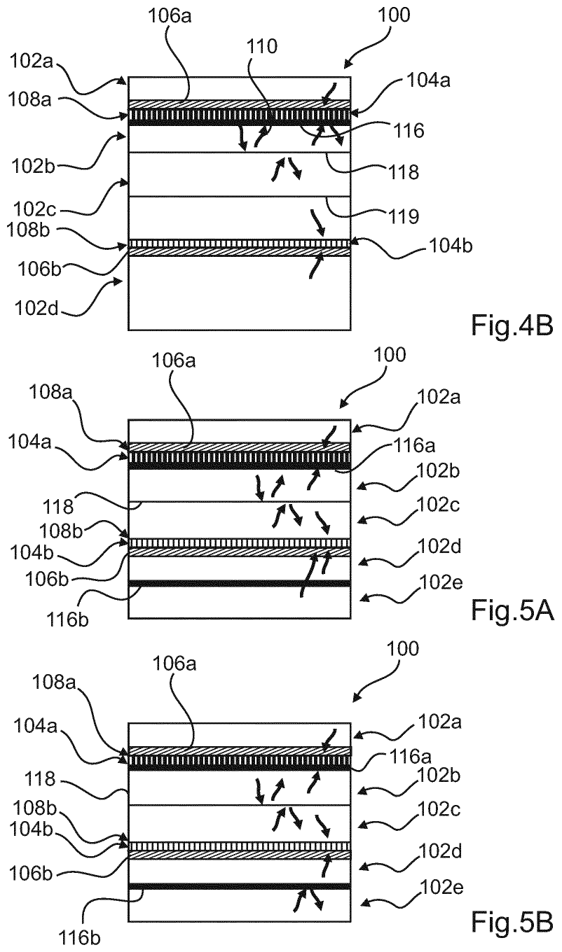

Given the fact that scintillator light 110 is generated and/or emitted in each spatial direction, the second sensor array 104b of FIG. 4D is also configured to primarily detect the high energy portion of X-ray radiation.

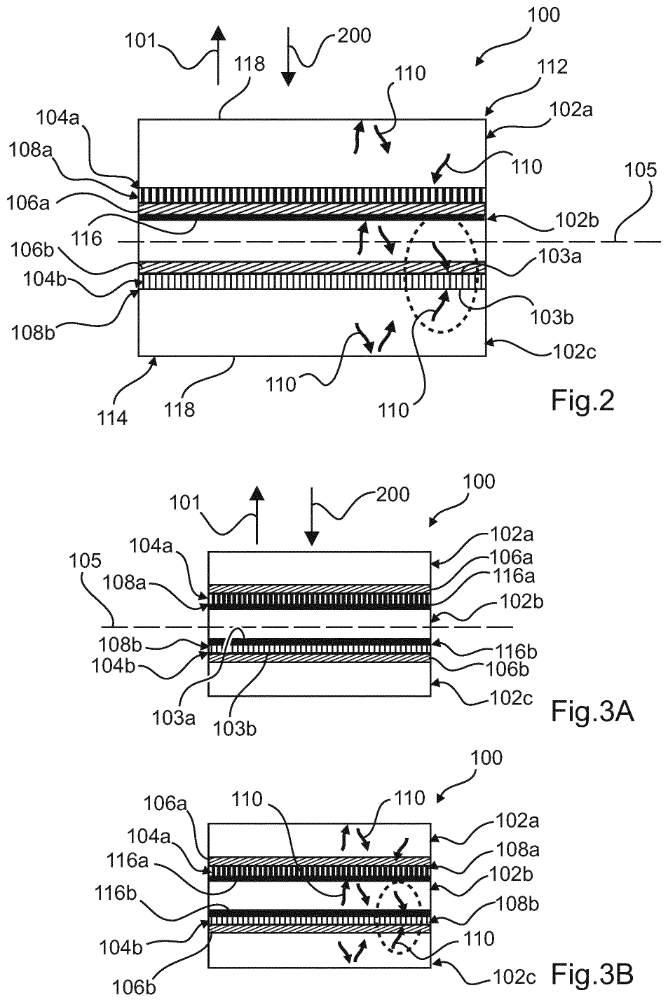

FIG. 2 shows schematically an X-ray detector 100 according to an embodiment. If not stated otherwise, the X-ray detector 100 of FIG. 2 comprises the same features and/or elements as the X-ray detectors 100 shown in previous figures.

The X-ray detector 100 of FIG. 2 generally comprises a plurality of scintillator layers 102a, 102b, 102c and a plurality of sensor arrays 104a, 104b, wherein a number of scintillator layers 102a-c is larger than a number of sensor arrays 104a,b, i.e. the X-ray detector 100 comprises more scintillator layers 102a-c than sensor arrays 104a,b. In the example shown in FIG. 2, the X-ray detector 100 comprises in total three scintillator layers 102a-c and two sensor arrays 104a,b. Thus, the detector 100 of FIG. 2 may refer to a dual energy detector 100. However, the X-ray detector 100 may also comprise more than three scintillator layers 102a-c and/or more than two sensor arrays 104a,b.

More specifically, the X-ray detector 100 of FIG. 2 comprises a first outer scintillator layer 102a arranged on a first outer side 112 of the X-ray detector 100. The first outer side 112 may refer to a side of the X-ray detector 100, onto which X-ray radiation may impinge first along the impinging direction 200.

The X-ray detector 100 further comprises a second outer scintillator layer 102c arranged on a second outer side 114 of the X-ray detector 100. The first outer side 112 and the second outer side 114 of the X-ray detector 100 oppose each other and/or are arranged opposite to each other.

Further, the X-ray detector 100 comprises a center scintillator layer 102b arranged between the first outer scintillator layer 102a and the second outer scintillator layer 102c.

Moreover, the X-ray detector 100 comprises a first sensor array 104a arranged between the first outer scintillator layer 102a and the center scintillator layer 102b. A second sensor array 104b is arranged between the center scintillator layer 102b and the second outer scintillator layer 102c.

Accordingly, along the stacking direction 101 the X-ray detector 100 is composed of the second outer scintillator layer 102c, the second sensor array 104b, the center scintillator layer 102b, the first sensor array 104a, and the first outer scintillator layer 102a. Apart from that, the X-ray detector 100 is symmetric and/or symmetrically arranged with respect to a center plane 105 of the X-ray detector 100. Therein, the center plane 105 may be orthogonal to the stacking direction 101 and parallel to the first and/or second sides 112, 114 of the X-ray detector 100.

The first sensor array 104a comprises a first substrate 106a, on which a plurality of photosensitive pixels 108a is arranged. The first substrate 106a may be arranged on a side of the first sensor array 104a facing the center scintillator layer 102b or alternatively on a side of the first sensor array 104a facing the first outer scintillator layer 102a. Similarly, the second sensor array 104b comprises a second substrate 106b, on which a plurality of photosensitive pixels 108b is arranged. The second substrate 106b may be arranged on a side of the second sensor array 104b facing the center scintillator layer 102b or alternatively on a side of the second sensor array 104b facing the second outer scintillator layer 102c. The first and second substrates 106a,b may be thin and/or ultra-thin substrates. The first and second substrates 106a,b may comprise glass and/or polymer material. By way of example, the first and second substrates 106a,b may be substrate foils comprising Polylmide (PI), PolyTetraFluoroEthylene (PTFE), PolyEthylene Terephtalate (PET), PolyEthylen Naphtalate (PEN), and/or any combination thereof. A thickness of each of the first and second substrates 106a,b may range from several μm to about 1 mm, and particularly from about 5 μm to 500 μm, more particularly from about 10 μm to about 100 μm. Each of (or at least one of) the first and second substrates 106a,b may be transparent for scintillator light 110.

The photosensitive pixels 108a,b may be arranged in an arbitrary pattern on the respective first or second substrate 106a,b. However, pixels 108a,b may be arranged in several columns and/or several rows in the respective substrate 106a,b. Apart from that, also read-out electronics for receiving electrical signals from the photosensitive pixels 108a,b and/or addressing electronics for addressing the photosensitive pixels 108a,b may be arranged on the respective first and/or second substrate 106a,b.

A first side 103a of the second sensor array 104b is optically coupled to the center scintillator 102b, such that the second sensor array 104b receives and/or collects scintillator light 110 emitted by the center scintillator layer 102b at the first side 103a. A second side 103b of the second sensor array 104b, which second side 113b opposes and/or is arranged opposite to the first side 103a, is optically coupled the second outer scintillator layer 102c, such that the second sensor array 104b receives and/or collects scintillator light 110 emitted by the second outer scintillator layer 102c at the second side 103b. Thus, the second sensor array 104b receives and/or collects scintillator light 110 from two scintillator layers 102b, 102c, which are arranged on two opposite sides 103a, 103b of the second sensor array 104b, as depicted in the encircled region in FIG. 2. Generally, this allows to design the center scintillator layer 102b thinner than e.g. the second scintillator layer 102b shown in the example of FIG. 1C, which in turn results in an increased DQE (detective quantum efficiency) and/or in an optimized MTF (modulation transfer function).

In analogy to the second sensor array 104b, also the first sensor array 104a may be configured to receive and/or collect scintillator light 110 from two opposite sides of the first sensor array 104a. Accordingly, the first sensor array 104a may be optically coupled to the first outer scintillator layer 102a on a first side of the sensor array 104a, and optically coupled to the center scintillator layer 102b on a second side of the sensor array 104 opposite to the first side.

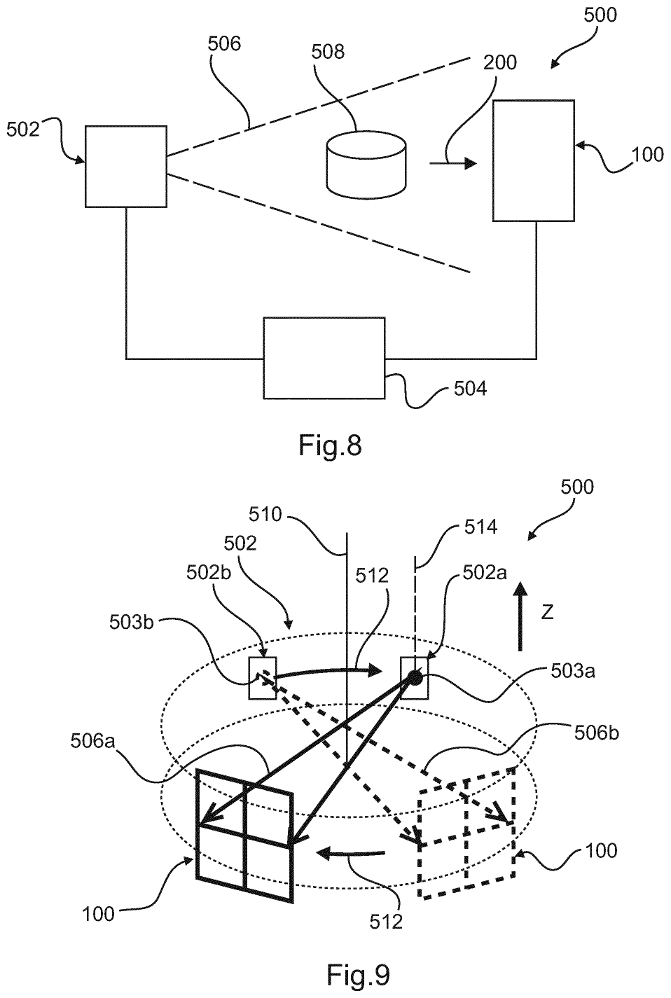

However, in the example shown in FIG. 2, a switchable optical filter 116 is arranged between the first sensor array 104a and the center scintillator layer 102b. It is to be noted that the switchable optical filter 116 is optional only. The switchable optical filter 116 is switchable between a first state, in which the switchable optical filter 116 is transparent for scintillator light 110, and a second state, in which the switchable optical filter 116 is blocking scintillator light 110. In the second state the scintillator light 110 may be absorbed by the switchable optical filter 116 and/or it may be reflected by the switchable optical filter 116. The switchable optical filter 116 may be configured to switch between the first state and the second state by receiving an electrical signal, e.g. from a controller of an X-ray imaging apparatus (see FIGS. 7 and 8) and/or from a controller of the X-ray detector 100. The switchable optical filter 116 may comprise e.g. viologen, transition metal oxide, such as e.g. tungsten trioxide, and/or any other suitable material. The switchable optical filter 116 may alternatively or additionally comprise one or more liquid crystals.

The first substrate 106a may be arranged on a side of the first sensor array 104a facing the center scintillator layer 102b or alternatively on a side of the first sensor array 104a facing the first outer scintillator layer 102a. In the embodiment shown in FIG. 2, the switchable optical filter 116 is in contact with the first substrate 106a. However, the first sensor array 104a may also be arranged, such that the switchable optical filter 116 may be in contact with the photosensitive pixels 108a and/or a protective layer covering at least a part of the photosensitive pixels 108a.

It is to be noted that a metal layer and/or metal filter may be arranged at the center plane 105. Such metal layer and/or metal filter may be a metal spectral-separation filter also acting as reflector. This may allow the X-ray detector 100 to be operated in at least two modes of operation, wherein applications requiring medium spectral separation the switchable optical filter 116 may be opaque in the second state, while for applications requiring high spectral separation the switchable optical filter 116 may be black in the second state, thus adding the scintillator layer 102b to the spectral separation filter and/or using scintillator layer 102b as spectral separation filter.

In the example shown in FIG. 2, the switchable optical filter 116 is switched to the second state, in which scintillator light 110 is reflected by the switchable optical filter 116, as indicated by the arrows depicting scintillator light 110 hitting the switchable optical filter 116. As a consequence, the first sensor array 104a is optically decoupled from the center scintillator layer 102b and only receives scintillator light 110 emitted by the first outer scintillator layer 102a. However, by switching the switchable optical filter 116 to the first state, the first sensor array 104a may be optically coupled to the center scintillator layer 102b, such that it receives scintillator light 110 from two opposite sides. Accordingly, by means of the switchable optical filter 116 a versatility of the X-ray detector 100 is increased, as the X-ray detector 100 may be operated in a plurality of operation modes by switching the switchable optical filter 116 to the first or second state. In an alternative embodiment the switchable filter may be replaced by a metal filter and/or a metal layer. Also, the X-ray detector 100 may comprise a metal filter and/or metal layer in addition to the switchable optical filter 116.

Further, it is to be noted that scintillator light 110 on the first side 112 of the X-ray detector 100 and on the second side 114 of the X-ray detector 100 may be reflected e.g. by arranging a reflective film 118 and/or a reflective layer 118 on the respective side 112, 114 and/or surface of the X-ray detector 100. However, the layers 118 may also be opaque layers 118 absorbing scintillator light 110.

When X-ray radiation with a certain energy distribution hits the X-ray detector 100 along the impinging direction 200, the low energy portion of the X-ray radiation is primarily converted to scintillator light 110 in the first outer scintillator layer 102. As the switchable optical filter 116 is in the second state, the first sensor array 104a only collects scintillator light 110 generated by the low-energy portion. Thus, the first sensor array 104a only detects low-energy X-ray radiation and acquires a low-energy X-ray image. In contrast, the high-energy portion of the X-ray radiation is mainly converted into scintillator light 110 in the center scintillator layer 102b and/or the second outer scintillator layer 102c. As the second sensor array 104b receives scintillator light 110 from both theses scintillator layers 102b, c, the second sensor array 104b detects the high-energy portion and acquires a high-energy X-ray image with high detection efficiency.

Moreover, it is to be noted, that each of the scintillator layers 102a-c may comprise any suitable scintillation material, such as e.g. CsI, GOS (Gadolinium Oxysulfide), garnet (e.g. LGGAG, Lutetium Gadolinium Gallium Aluminum Garnet), and/or NaL Further, the scintillator material may be a columnar grown scintillator material and/or a non-columnar grown scintillator material. The scintillator layers 102a-c of the X-ray detector 100 may comprise the same scintillator material or at least a part of the scintillator layers 102a-c may comprise different scintillator materials. By way of example, it may be favorable that the center scintillator layer 102b comprises scintillator material different from the scintillator material of the first and/or second outer scintillator layers 102a, c in order to optimize energy separation between the first sensor array 104a, and the second sensor array 104b.

Moreover, the scintillator layers 102a-2 may each have the same thickness, which is measured along the stacking direction 101, or at least a part of the scintillator layers 102a-c may have different thicknesses. Particularly, the first outer scintillator layer 102a may be thinner than the center scintillator layer 102b and/or the second outer scintillator layer 102c. Also, the center scintillator layer 102b and the second outer scintillator layer 102c may have the same thickness or different thicknesses. By way of example, the first outer scintillator layer 102a may have a thickness of about 0.1 mm to about 1.0 mm, typically about 0.3 mm, whereas the center scintillator layer 102b and the second outer scintillator layer 102c each may have a thickness of about 0.5 mm to about 1.5 mm, typically about 0.8 mm.

For scintillator layers that can be designed thin, such as the first outer scintillator layer 102a, it may be favorable to use a scintillator material different from CsI, which may be cheaper, but still may have a similar MTF compared with other, potentially thicker CsI scintillator layers 102b, c. Further, for the first outer scintillator layer 102a that is preferably used for capturing the low-energy portion of the emitted X-ray spectrum, a different composition, having a lower effective Z-value, than the scintillator layers 102b, c that are preferably used to capture the high-energy portion of the emitted X-ray spectrum may be beneficial. This may increase the difference in the energy spectrum captured between the first sensor array 104a and the second sensor array 104b of the X-ray detector 100.

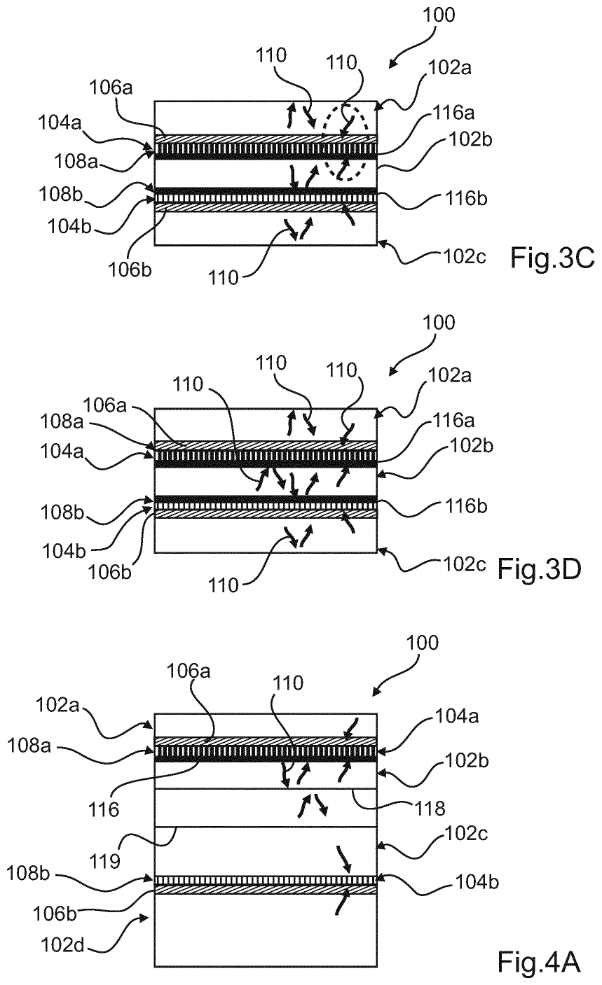

FIG. 3A shows schematically an X-ray detector according to an embodiment. If not stated otherwise, the X-ray detector 100 of FIG. 3A comprises the same features and/or elements as the X-ray detectors 100 shown in previous figures. FIGS. 3B, 3C, 3D each schematically illustrate an operation mode of the X-ray detector 100 of FIG. 3A.

The X-ray detector 100 shown in FIG. 3A particularly comprises the same features and/or elements as the X-ray detector 100 shown FIG. 2. However, the switchable optical filter 116 of FIG. 2 is depicted as first switchable optical filter 116a in FIG. 3A. In addition to this first switchable optical filter 116a, the X-ray detector 100 of FIG. 3A comprises a second switchable optical filter 116b arranged between the second sensor array 104b and the center scintillator layer 102b. By arranging the first switchable optical filter 116a and the second switchable optical filter 116b between the first sensor array 104a and the second sensor array 104b, the X-ray detector 100 may be operated in a plurality of operation modes as indicated in FIGS. 3B, 3C and 3D.

It is to be noted that the first substrate 106a of the first sensor array 104a may be arranged on a side of the first sensor array 104a facing the center scintillator layer 102b or alternatively on a side of the first sensor array 104a facing the first outer scintillator layer 102a. Accordingly, the first switchable optical filter 116a may be in contact with the first substrate 106a or it may be in contact with the photosensitive pixels 108a and/or a protection layer covering the photosensitive pixels of the first sensor array 104a. Further, the second substrate 106b of the second sensor array 104b may be arranged on a side of the second sensor array 104b facing the center scintillator layer 102b or alternatively on a side of the second sensor array 104b facing the second outer scintillator layer 102c. Accordingly, the second switchable optical filter 116b may be in contact with the second substrate 106b or it may be in contact with the photosensitive pixels 108b and/or a protection layer covering the photosensitive pixels of the second sensor array 104b.

Referring to FIG. 3B, the first switchable optical filter 116a is switched to the second state, in which scintillator light 110 is reflected by the first switchable optical filter 116a. Thus, the first sensor array 104a only detects scintillator light 110 generated primarily by low-energy X-ray photons in the first outer scintillator layer 102a.

In contrast to the first switchable optical filter 116a, the second switchable optical filter 116b is switched to the first state, such that the second sensor array 104b is optically coupled to the center scintillator layer 102b and the second outer scintillator layer 102c. Accordingly, the second sensor array 104b receives scintillator light from both these scintillator layers 102b, c at two opposite sides 103a, 103b of the second sensor array 104b, as shown in the encircled region in FIG. 3B. In other words, the second sensor array 104b is illuminated with scintillator light 110 from two opposite sides 103a,b of the second sensor array 104b.

Referring to FIG. 3C, the first switchable optical filter 116a is switched to the first state and the second optical filter 116b is switched to the second state. Accordingly, scintillator light 110 is reflected by the second switchable optical filter 116b, and the first side 103a of the second sensor array 104b is optically decoupled from the center scintillator layer 102b, such that the second sensor array 104b only receives and/or detects scintillator light 110 from the second outer scintillator layer 102c. In contrast thereto, the first sensor array 104a is optically coupled on one side to the first outer scintillator layer 102a and on an opposite side to the center scintillator layer 102b. Thus, the first sensor array 104a receives and/or detects scintillator light 110 from both these layers 102a, 102b, as shown in the encircled region in FIG. 3C. In other words, the first sensor array 104a is illuminated from two opposite sides of the first sensor array 104a by scintillator light 110.

Referring to FIG. 3D, both the first switchable optical filter 116a and the second switchable optical filter 116b are switched to the second state, in which scintillator light 110 is reflected. Accordingly, the first sensor array 104a is optically coupled only to the first outer scintillator layer 102a, and the second sensor array 104b is optically coupled only to the second outer scintillator layer 102c. Thus, in this operation mode, the center scintillator layer 102b may be regarded as being “switched off”. Nonetheless, the center scintillator layer 102b contributes to the energy separation between the first sensor array 104a and the second sensor array 104b. In other words, scintillator light 110 from the center scintillator layer 102b neither contributes to the low-energy image captured with the first sensor array 104 nor to the high-energy image captured with the second sensor array 104b. Thus, the center scintillator layer 102b may be regarded as an extra filter increasing energy separation.

FIGS. 4A and 4B show schematically an X-ray detector 100 according to an embodiment. If not stated otherwise, the X-ray detector 100 of FIGS. 4A and 4B comprises the same features and/or elements as the X-ray detectors 100 shown in previous figures.

The X-ray detector 100 of FIGS. 4A and 4B comprises in total four scintillator layers 102a-d. A first outer scintillator layer 102a, a second outer scintillator layer 102d, a first center scintillator layer 102b, and a second center scintillator layer 102c, wherein the center scintillator layers 102b, 102c are arranged between the first sensor array 104a and the second sensor array 104b. The first outer scintillator layer 102a and the first center scintillator layer 102b may have the same thickness ranging from about 0.1 mm to about 1.0 mm, e.g. about 0.3 mm. Further, the second center scintillator layer 102b and the second outer scintillator layer 102d may have the same thickness ranging from about 0.5 mm to about 1.5 mm, e.g. about 0.8 mm.

Moreover, a reflective and non-switchable layer 118 is arranged between the first and second center scintillator layers 102b, 102c. By means of the reflective layer 118, scintillator light 110 from both, the first and the second center scintillator layers 102b, 102c is reflected. This may increase an overall detection efficiency. However, the reflective layer may alternatively be an opaque layer 118. Layer 118 may be reflective and/or opaque on both sides, which are in contact with the scintillator layers 102b, 102c. Also, one side of the layer 118 may be opaque and an opposite side may be reflective.

Further, a switchable optical filter 116 is arranged between the first sensor array 104a and the first center scintillator layer 102b.

It is to be noted that the first substrate 106a of the first sensor array 104a may be arranged on a side of the first sensor array 104a facing the first center scintillator layer 102b or alternatively on a side of the first sensor array 104a facing the first outer scintillator layer 102a. Accordingly, the switchable optical filter 116a may be in contact with the first substrate 106a or it may be in contact with the photosensitive pixels 108a and/or a protection layer covering the photosensitive pixels of the first sensor array 104a.

In FIG. 4A the switchable optical filter 116 is in the first state and in FIG. 4B the switchable optical filter 116 is in the second state. Accordingly, in FIG. 4A the first and the second sensor arrays 104a, 104b are illuminated from two opposite sides, whereas in FIG. 4B only the second sensor array 104b is illuminated from two opposite sides.

The switchable optical filter 116 in the first state as shown in FIG. 4A may advantageously increase an overall absorption of X-ray radiation, which may be favorable in a non-spectral imaging mode of the detector 100. In contrast, the switchable optical filter 116 in the second state as shown in FIG. 4B may advantageously increase energy separation, which may be favorable in spectral X-ray imaging.

Optionally, a metal filter 119 may be arranged in any of the scintillator layers 102a-d, which may increase an energy separation between the first and second sensor array 104a, 104b. Such metal filter 119 may be arranged additionally or alternatively to the reflective and/or opaque layer 118.

Moreover, the embodiment shown in FIGS. 4A and 4B may advantageously be used in dual beam applications. By way of example, when a high-energy beam is used for imaging, the switchable optical filter 116 may be switched to the second state as shown in FIG. 4B. This way, a high-energy image may be captured with the second sensor array 104b, while the first sensor array 104a may capture a low-energy image at this beam energy. Further, when a low-energy beam is used, the switchable optical filter may be switched to the first state as shown in FIG. 4A, thus both the first sensor array 104a and the second sensor array 104b may capture a low-energy image. The low-energy images of all exposures may then be added, allowing to increase dose efficiency. The low-energy image of the low energy beam could be used to generate more than two images of different mean absorbed X-ray energy.

FIGS. 5A and 5B show schematically an X-ray detector 100 according to an embodiment. If not stated otherwise, the X-ray detector 100 of FIGS. 5A and 5B comprises the same features and/or elements as the X-ray detectors 100 shown in previous figures.

The X-ray detector comprises in total five scintillator layers 102a-102e, each having the same thickness ranging from 0.1 mm to about 1.0 mm, e.g. about 0.3 mm. In contrast to the embodiment shown in FIGS. 4A and 4B, the X-ray detector 100 of FIGS. 5A and 5B comprises a further scintillator layer 102d arranged between the second sensor array 104b and the second outer scintillator layer 102e. Between the further scintillator layer 102d and the second outer scintillator layer 102e, a second switchable optical filter 116b is arranged in addition to the first switchable optical filter 116a, which is arranged between the first sensor array 104a and the first center scintillator layer 102b.

It is to be noted that the first substrate 106a of the first sensor array 104a may be arranged on a side of the first sensor array 104a facing the first center scintillator layer 102b or alternatively on a side of the first sensor array 104a facing the first outer scintillator layer 102a. Accordingly, the first switchable optical filter 116a may be in contact with the first substrate 106a or it may be in contact with the photosensitive pixels 108a and/or a protection layer covering the photosensitive pixels of the first sensor array 104a. Further, the second sensor array 104b may be arranged such that the second substrate 106b may be in contact with the further scintillator layer 102d or such that it may be in contact with the second center scintillator layer 102c.

In FIG. 5A both the first and the second switchable optical filters 116a, 116b are in the first state, whereas in FIG. 5B, the second switchable optical filter 116b is switched to the second state. When both switchable optical filters 116a, 116b are in the first state as shown in FIG. 5A, an overall absorption of X-ray radiation may be increased. This operation mode may e.g. be used when imaging thick objects, e.g. obese patients. In contrast, when the second optical filter 116b is switched to the second state as shown in FIG. 5B, a resolution may be increased, which may e.g. be used for imaging thin objects, such as e.g. vessels.

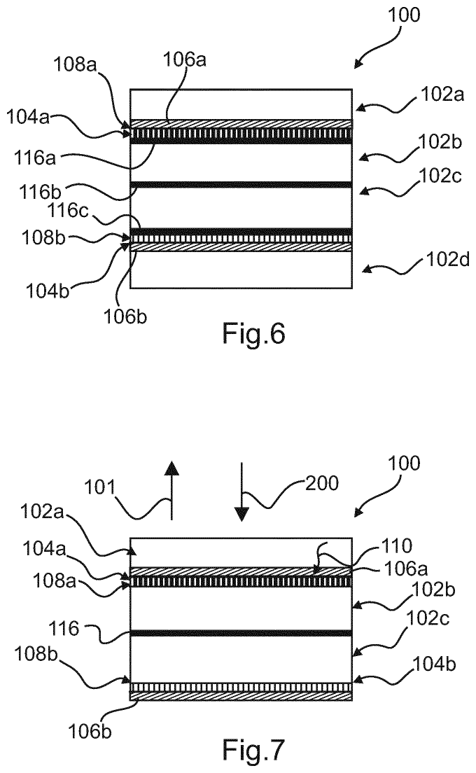

FIG. 6 shows schematically an X-ray detector 100 according to an embodiment. If not stated otherwise, the X-ray detector 100 of FIG. 6 comprises the same features and/or elements as the X-ray detectors 100 shown in previous figures.

The X-ray detector 100 of FIG. 6 comprises in total four scintillator layers 102a-102d. More specifically, the detector 100 comprises a first outer scintillator layer 102a, a second outer scintillator layer 102d, a first center scintillator layer 102b and a second center scintillator layer 102c, wherein the two center scintillator layers 102b, 102c are arranged between the first sensor array 104a and the second sensor array 104b.

Between the first sensor array 104a and the first center scintillator layer 102b a first switchable optical filter 116a is arranged.

Further, between the first center scintillator layer 102b and the second scintillator layer 102b, a second switchable optical filter 116b is arranged.

Moreover, a third switchable optical filter 116c is arranged between the second sensor array 104b and the second center scintillator layer 102c.

By arranging three switchable optical filters 116a-116c in the X-ray detector 100, a number of operation modes of the X-ray detector 100 may be further increased.

It is to be noted that the first substrate 106a of the first sensor array 104a may be arranged on a side of the first sensor array 104a facing the first center scintillator layer 102b or alternatively on a side of the first sensor array 104a facing the first outer scintillator layer 102a. Accordingly, the first switchable optical filter 116a may be in contact with the first substrate 106a or it may be in contact with the photosensitive pixels 108a and/or a protection layer covering the photosensitive pixels 108a of the first sensor array 104a. Further, the second substrate 106b of the second sensor array 104b may be arranged on a side of the second sensor array 104b facing the second center scintillator layer 102c or alternatively on a side of the second sensor array 104b facing the second outer scintillator layer 102d. Accordingly, the third switchable optical filter 116c may be in contact with the second substrate 106b or it may be in contact with the photosensitive pixels 108b and/or a protection layer covering the photosensitive pixels 108b of the second sensor array 104b.

FIG. 7 shows schematically an X-ray detector 100 according to an embodiment. If not stated otherwise, the X-ray detector 100 of FIG. 7 comprises the same features and/or elements as the X-ray detectors 100 shown in previous figures.

The X-ray detector 100 of FIG. 7 comprises in total three scintillator layers 102a, 102b, 102c. More specifically, the X-ray detector 100 comprises an outer scintillator layer 102a arranged on a first outer side of the X-ray detector 100. The two further scintillator layers 102b, 102c are arranged between the first sensor array 104a and the second sensor array 104b, such that the first and second sensor arrays 104a, 104b are separated by the two scintillator layers 102b, 102c along the stacking direction 101.

Further, a switchable optical filter 116 is arranged between scintillator layer 102b and scintillator layer 102c, such that the two scintillator layers 102b, 102c are separated by the switchable optical filter 116 along the stacking direction 101.

In the embodiment shown in FIG. 7 the second sensor array 104b is arranged on a second outer side of the X-ray detector 100 opposite to the side, on which the first outer scintillator layer 102a is arranged. Accordingly, the first sensor array 104a is arranged to collect and/or receive scintillator light 110 from two opposite sides, i.e. at least from the scintillator layers 102a, 102b, whereas the second sensor array 104b is arranged to receive and/or collect scintillator light 110 from one side only, i.e. at least from scintillator layer 102c.

In the embodiment shown in FIG. 7 X-ray radiation impinges along impinging direction 200 onto the X-ray detector 100, wherein the outer scintillator layer 102 is hit first by the X-ray radiation. In other words, the outer scintillator layer 102a may be arranged towards to, in direction of and/or facing an X-ray source. However, it is to be noted, that the X-ray detector 100 may also be arranged such that X-ray radiation first impinges onto the second senor array 104b and/or the second substrate 106b. In other words, the second sensor array 104b may be arranged towards to, in direction of and/or facing to an X-ray source.

The first substrate 106a of the first sensor array 104a may be arranged such that the first substrate 106a is in contact with the outer scintillator layer 102a or such that it is in contact with scintillator layer 102b. Similarly, the second substrate 106b of the second sensor array may be arranged such that it is in contact with scintillator layer 102c or such that the photosensitive pixels 108b of the second sensor array 104b or a protection layer covering the photosensitive pixels 108b is in contact with scintillator layer 102c.

Further, it is to be noted that in any of the embodiments shown in FIGS. 2 to 7, the switchable optical filter 116, 116a, 116b, 116c may have a pixel structure and/or the switchable optical filter 116, 116a, 116b, 116c may be a pixelated switchable optical filter. In other words, the switchable optical filter 116, 116a, 116b, 116c may comprise an array of switchable optical filter elements. The pixel structure of the switchable optical filter 116, 116a, 116b, 116c may correlate with a geometrical arrangement of the photosensitive pixels 108a, 108b of at least one of the sensor arrays 104a, 104b. Accordingly, the pixel structure of the switchable optical filter 116, 116a, 116b, 116c may be matched with at least one of the sensor arrays 104a, 104b and/or with a geometrical arrangement of the photosensitive pixels 108a, 108b of at least one of the sensor arrays 104a, 104b. The state of the switchable optical filter 116, 116a, 116b, 116c may be the same for all switchable optical filter elements or the state may be controlled pixel-wise, such that a part of the switchable optical filter elements may be in the first state and another part of the switchable optical filter elements may be in the second state. Therein, each switchable optical filter element may be controlled and/or switched independently. Also, the X-ray detector 100 may comprise any combination of at least one pixelated switchable optical filter 116, 116a, 116b, 116c with a plurality of switchable optical filter elements and at least one un-pixelated switchable optical filter 116, 116a, 116b, 116c.

FIG. 8 shows schematically an X-ray imaging apparatus 500 according to an embodiment.

The X-ray imaging apparatus 500 comprises an X-ray source arrangement 502. The X-ray source arrangement may be a single X-ray source or a multi X-ray source comprising two or more X-ray sources.

The X-ray imaging apparatus 500 further comprises an X-ray detector 100 as described above and in the following. Particularly, the X-ray detector 100 may be an X-ray detector 100 as described in more detail with reference to FIGS. 2 to 7. However, it is to be noted that the X-ray imaging apparatus 500 is not restricted to an X-ray detector 100 as shown in previous figures, but rather can comprise any type of X-ray detector.

Further, the X-ray imaging apparatus 500 comprises a controller 504 for controlling the X-ray source arrangement 502 and/or the X-ray detector 100. The controller 504 may refer to a control circuitry 504, a control module 504 and/or a control unit 504. The controller 504 may particularly be configured to trigger an emission of an X-ray beam 506, which X-ray beam 506, after passing through an object 508 to be examined, is detected by means of the X-ray detector 100. Moreover, the controller 504 may be configured to switch a switchable optical filter 116, which may be present in the X-ray detector 100 as described with reference to FIGS. 2 to 7. Further, the controller 504 may be configured for image processing and/or for data processing of X-ray images acquired and/or captured with the X-ray detector 100.

The X-ray imaging apparatus 500 may be any type of X-ray imaging apparatus, such as, e.g. a CT imaging apparatus, a CBCT imaging apparatus, a cone beam imaging apparatus or a C-arm system.

FIG. 9 shows schematically an X-ray imaging apparatus 500 according to an embodiment. Particularly, FIG. 9 illustrates an operation of the imaging apparatus 500. If not stated otherwise, the X-ray imaging apparatus 500 of FIG. 9 comprises the features and/or elements as the X-ray imaging apparatus 500 of FIG. 8. For simplicity, the controller 504 is not shown in FIG. 9.

In the X-ray imaging apparatus 500 the X-ray detector 100 and the X-ray source arrangement 502 are rotatable around a rotational axis 510 of the X-ray imaging apparatus 500. As indicated in FIG. 9, the rotational axis 510 may be parallel to a z-axis. The rotational movement of the X-ray detector 100 and the X-ray source arrangement 502 is illustrated by the arrows 512 in FIG. 9. It is to be noted that a rotation radius of the X-ray detector 100 and the X-ray source arrangement 502 may differ from each other.

The X-ray source arrangement 502 comprises a first X-ray source 502a for emitting a first X-ray beam 506a of a first energy range and a second X-ray source 502b for emitting a second X-ray beam 506b of a second energy range different from the first energy range.

The controller 504 is configured for triggering the first X-ray source 502a and for acquiring a first X-ray image, when the first X-ray source 502a is located at an acquiring position 514 around the rotational axis 510. Further, the controller 504 is configured for triggering the second X-ray source 502b and for acquiring a second X-ray image, when the second X-ray source 502b is located at the acquiring position 514 around the rotational axis 510.

Accordingly, when an X-ray source arrangement 502 comprising the first X-ray source 502a and the second X-ray source 502b is used, a first X-ray image is captured by activating the first X-ray source 502a at the acquiring position 514. After a certain period of time, the second X-ray source 502b may, due to the rotational movement, arrive at the acquiring position 514. When the second X-ray source 502b arrives at the acquiring position, the second X-ray image is captured. This way, the rotation speed and the exposures, e.g. taking into account a distance between the first and second X-ray sources 502a, 502b, may be synchronized. In other words, an acquisition frequency may be synchronized with a rotation frequency of the X-ray imaging apparatus 500. This allows the first X-ray image to be coincident in space with the second X-ray image.

It is to be noted, that also by using a single X-ray source 502, 502b this synchronization can be achieved by rotating the X-ray source 502a, 502b completely by 360° around the rotational axis 510.

Further it is to be noted that this synchronization is applicable in kVp-switching approaches, in which the first X-ray beam 506a and the second X-ray beam 506b are generated by means of a pre-filter.

Moreover, this synchronization is applicable for a stereo X-ray tube and/or for a dual focal spot X-ray source arrangement 502. In other words, the X-ray source arrangement 502 may comprise an X-ray tube with a first focal spot 503a for emitting the first X-ray beam 506a and a second focal spot 503b for emitting the second X-ray beam 506b. Alternatively or additionally the X-ray source arrangement 502 may comprise a first X-ray tube 503a for emitting the first X-ray beam 506a and a second X-ray tube 503b for emitting the second X-ray beam 506b.

Moreover, it is to be noted that using the X-ray detector 100 as described with reference to at least one of FIGS. 2 to 7 during each exposure, i.e. when the first beam 506a or the second beam 506b is emitted, the first sensor array 104a as well as the second sensor array 104b captures a separate X-ray image. Accordingly, the first X-ray image acquired during exposure with the first beam 506a refers to a first image pair. Similarly, the second X-ray image acquired during exposure with the second beam 506b refers to a second image pair, wherein the image pairs may be coincident in time and space. Acquiring the first and the second X-ray images thus results in total in four images, which can be advantageously combined in order to increase dose efficiency of the X-ray imaging apparatus 500.

By way of example, the first beam 506a may be a low kV beam 506a and the second beam 506b may be a high kV beam 506b. When exposing the X-ray detector 100 with the low kV beam 506a, both the first sensor array 104a and the second sensor array 104b capture and/or acquire a low-energy image. In contrast, when exposing the X-ray detector 100 with the high kV beam 506b, the first sensor array 104a acquires and/or captures a low-energy image, whereas the second sensor array 104b captures and/or acquires a high-energy image. The three low-energy images acquired during both exposures, i.e. during exposure with the low kV beam 506a and the high kV beam 506b, may advantageously be added and/or combined. This results in a dose efficient low-energy total image.

Moreover, adding and/or combining all four images gives a dose efficient non-spectral image.

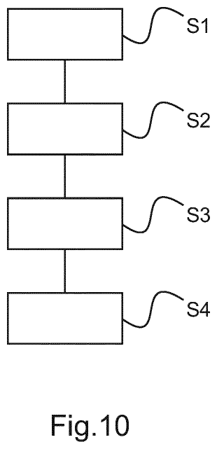

FIG. 10 shows a flow chart illustrating steps of a method for operating an X-ray imaging apparatus 500 according to an embodiment. If not stated otherwise, the X-ray imaging apparatus 500 comprises the same features and/or elements as the X-ray imaging apparatus 500 of FIGS. 8 and 9. Particularly, the X-ray imaging apparatus 500 comprises an X-ray detector 100 as described with reference to FIGS. 2 to 7.

The X-ray imaging apparatus 500 comprises an X-ray source arrangement 502 with a first X-ray source 502a for emitting a first X-ray beam 506a of a first energy range and a second X-ray source 502b for emitting a second X-ray beam 506b of a second energy range different from the first energy range.

The method comprises a step Si of emitting the first X-ray beam 506a with the first X-ray source 502a, when the first X-ray source 502a is located at an acquiring position 514 around a rotational axis 510 of the X-ray imaging apparatus 500.

In a step S2 a first X-ray image is acquired and/or captured with the X-ray detector 100, when the first X-ray source 502a is located at the acquiring position 514.

In a further step S3 the second X-ray beam 506b is emitted with the second X-ray source 502b, when the second X-ray source 502b is located at the acquiring position 514. Further, in a step S4 a second X-ray image is acquired and/or captured with the X-ray detector 100, when the second X-ray source 502b is located at the acquiring position 514.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An X-ray detector, comprising:
at least three scintillator layers for converting X-ray radiation into scintillator light; and
at least two sensor arrays, each comprising a plurality of photosensitive pixels for receiving scintillator light emitted by at least one of the scintillator layers;
wherein the photosensitive pixels of each of the sensor arrays are arranged on a bendable substrate;
wherein a number of the scintillator layers is larger than a number of the sensor arrays;
wherein the at least three scintillator layers and the at least two sensor arrays are arranged on top of each other;
wherein at least one of the sensor arrays is arranged between at least two of the scintillator layers, such that said at least two scintillator layers are optically coupled to said at least one sensor array at two opposite sides of said at least one sensor array; and
wherein said at least one sensor array is configured to receive light emitted by said at least two scintillator layers.

2. The X-ray detector according to claim 1,
wherein each of the at least two sensor arrays is arranged between at least two of the scintillator layers; and
wherein each of the sensor arrays is configured to receive light emitted by at least two of the scintillator layers arranged on two opposite sides of the respective sensor array.

3. The X-ray detector according to claim 1, further comprising:
at least one switchable optical filter
switchable between a first state in which the switchable optical filter is transparent for the scintillator light and a second state in which the switchable optical filter is blocking the scintillator light.

4. The X-ray detector according to claim 3, wherein the at least one switchable optical filter is an electrochromic optical filter.

5. The X-ray detector according to claim 3, wherein the at least one switchable optical filter is arranged between the at least two sensor arrays.

6. The X-ray detector according to claim 3,
wherein the X-ray detector comprises at least one center scintillator layer arranged between the at least two sensor arrays; and
wherein the at least one switchable optical filter is arranged between at least one of the sensor arrays and the at least one center scintillator layer.

7. The X-ray detector according to claim 3, further comprising:
a first outer scintillator layer arranged on a first outer side of the X-ray detector;
a second outer scintillator layer arranged on a second outer side of the X-ray detector opposite the first outer side;
at least one center scintillator layer arranged between the at least two sensor arrays;
wherein the at least one switchable optical filter is arranged between each of the at least two sensor arrays and the at least one center scintillator layer.

8. The X-ray detector according to claim 7, wherein a further center scintillator layer is arranged between the at least two sensor arrays; and wherein at least one further switchable optical filter is arranged between the two center scintillator layers.

9. The X-ray detector according to claim 1, further comprising at least one opaque layer for absorbing scintillator light.

10. The X-ray detector according to claim 1, wherein the substrate comprises at least one of glass and polymer material.

11. The X-ray detector according to claim 1, further comprising at least one metal layer for filtering the X-ray radiation.

12. An X-ray imaging apparatus, comprising:
an X-ray source arrangement for emitting X-ray radiation;
an X-ray detector comprising:
at least three scintillator layers for converting the X-ray radiation into scintillator light; and
at least two sensor arrays, each comprising a plurality of photosensitive pixels for receiving scintillator light emitted by at least one of the scintillator layers;
wherein the photosensitive pixels of each of the sensor arrays are arranged on a bendable substrate;
wherein a number of the scintillator layers is larger than a number of the sensor arrays;
wherein the at least three scintillator layers and the at least two sensor arrays are arranged on top of each other;
wherein at least one of the sensor arrays is arranged between at least two of the scintillator layers, such that said at least two scintillator layers are optically coupled to said at least one sensor array at two opposite sides of said at least one sensor array; and
wherein said at least one sensor array is configured to receive light emitted by said at least two scintillator layers; and
a controller for controlling at least one of the X-ray source arrangement and the X-ray detector.

13. The X-ray imaging apparatus according to claim 12,
wherein the X-ray source arrangement and the X-ray detector are rotatable around a rotational axis of the X-ray imaging apparatus;
wherein the X-ray source arrangement comprises at least a first X-ray source for emitting a first X-ray beam of a first energy range and a second X-ray source for emitting a second X-ray beam of a second energy range different from the first energy range;
wherein the controller is configured to trigger the first X-ray source and acquire a first X-ray image, when the first X-ray source is located at an acquiring position around the rotational axis; and
wherein the controller is configured to trigger the second X-ray source and acquire a second X-ray image when the second X-ray source is located at the acquiring position around the rotational axis.

14. The X-ray imaging apparatus according to claim 13, wherein the X-ray source arrangement comprises an X-ray tube with a first focal spot for emitting the first X-ray beam and a second focal spot for emitting the second X-ray beam.

15. A method for operating an X-ray imaging apparatus with an X-ray detector according to claim 1 and an X-ray source arrangement;
wherein the X-ray source arrangement comprises a first X-ray source for emitting a first X-ray beam of a first energy range and a second X-ray source for emitting a second X-ray beam of a second energy range different from the first energy range; the method comprising the steps of:
emitting the first X-ray beam with the first X-ray source, when the first X-ray source is located at an acquiring position around a rotational axis of the X-ray imaging apparatus;
acquiring a first X-ray image with the X-ray detector, when the first X-ray source is located at the acquiring position;
emitting the second X-ray beam with the second X-ray source, when the second X-ray source is located at the acquiring position; and
acquiring a second X-ray image with the X-ray detector, when the second X-ray source is located at the acquiring position.

16. The X-ray imaging apparatus according to claim 13, wherein the X-ray source arrangement comprises a first X-ray tube for emitting the first X-ray beam and a second X-ray tube for emitting the second X-ray beam.

17. A method of operating X-ray imaging apparatus,
emitting X-ray radiation;
converting X-ray radiation into scintillator light using at least three scintillator layers; and
providing at least two sensor arrays, each comprising a plurality of photosensitive pixels for receiving scintillator light emitted by at least one of the scintillator layers;
wherein the photosensitive pixels of each of the sensor arrays are arranged on a bendable substrate;
wherein a number of the scintillator layers is larger than a number of the sensor arrays;
wherein the at least three scintillator layers and the at least two sensor arrays are arranged on top of each other;
wherein at least one of the sensor arrays is arranged between at least two of the scintillator layers, such that said at least two scintillator layers are optically coupled to said at least one sensor array at two opposite sides of said at least one sensor array; and
wherein said at least one sensor array is configured to receive light emitted by said at least two scintillator layers.

18. The X-ray detector according to claim 1, further comprising at least one reflective layer for reflecting scintillator light.
